(19) United States
(12) Patent Application Publication
(10) Pub. No.: US 2024/0062128 A1
(43) Pub. Date: Feb. 22, 2024

(54) INFORMATION PROCESSING APPARATUS, NON-TRANSITORY COMPUTER READABLE MEDIUM, AND INFORMATION PROCESSING METHOD

(71) Applicant: TOYOTA JIDOSHA KABUSHIKI KAISHA, Toyota-shi (JP)

(72) Inventors: Mitsuhiro MIURA, Nagoya-shi (JP); Kenichi YAMADA, Nisshin-shi (JP); Satoshi KOMAMINE, Nagoya-shi (JP); Fumiyuki KAGARA, Sagamihara-shi (JP); Go TANAKA, Toyota-shi (JP); Hiroyuki NISHIZAWA, Itabashi-ku (JP)

(73) Assignee: TOYOTA JIDOSHA KABUSHIKI KAISHA, Toyota-shi (JP)

(21) Appl. No.: 18/450,578

(22) Filed: Aug. 16, 2023

(30) Foreign Application Priority Data
Aug. 16, 2022 (JP) 2022-129727

(51) Int. Cl. G06Q 10/0631

(52) U.S. Cl. CPC G06Q 10/06312

(57) ABSTRACT

An information processing apparatus is configured to generate an operation plan for a vehicle transporting employees in a plant. The information processing apparatus includes a controller configured to acquire information regarding a work end time for each building or production line on the plant's premises, and generate the operation plan based on the information regarding the work end time.

### CROSS-REFERENCE TO RELATED APPLICATION

This application claims priority to Japanese Patent Application No. 2022-129727 filed on Aug. 16, 2022, the entire contents of which are incorporated herein by reference.

### TECHNICAL FIELD

The present disclosure relates to an information processing apparatus, a program, and an information processing method.

### BACKGROUND

Technology for automatically generating operation plans for vehicles such as buses, instead of generating the operation plans manually, is known.

For example, Patent Literature (PTL) 1 discloses a system that automatically makes a schedule for a shared vehicle based on customer usage requests, vehicle information on the shared vehicle, road network information, and the like.

### CITATION LIST

### Patent Literature

PTL 1: JP 2002-342873 A

### SUMMARY

In plants, vehicles such as on-premises buses may be operated to transport employees. Usually, such on-premises buses operate according to predetermined operation plans.

The plants often have fluctuating work end times depending on production conditions and other factors. Accordingly, the employees' clock-out times often vary from day to day and from building to building. As a result, operating the vehicles according to the predetermined operation plans every day may cause a shortage of vehicles during hours of the employees' leaving work when work end times are late due to overtime work.

There is room for improvement in generation of operation plans for transporting employees with high efficiency in plants.

It would be helpful to generate an operation plan for transporting employees with high efficiency in a plant.

An information processing apparatus according to the present disclosure is an information processing apparatus configured to generate an operation plan for a vehicle transporting employees in a plant, the information processing apparatus including a controller configured to:
acquire information regarding a work end time for each building or production line on the plant's premises; and
generate the operation plan based on the information regarding the work end time.

A program according to the present disclosure is configured to cause a computer to execute operations, the computer being configured to generate an operation plan for a vehicle transporting employees in a plant, the operations including:
acquiring information regarding a work end time for each building or production line on the plant's premises; and
generating the operation plan based on the information regarding the work end time.

An information processing method according to the present disclosure is an information processing method performed by an information processing apparatus configured to generate an operation plan for a vehicle transporting employees in a plant, the information processing method including:
acquiring information regarding a work end time for each building or production line on the plant's premises; and
generating the operation plan based on the information regarding the work end time.

According to the present disclosure, an operation plan for transporting employees with high efficiency in a plant can be generated.

### BRIEF DESCRIPTION OF THE DRAWINGS

In the accompanying drawings:

FIG. 1 is a diagram illustrating a configuration of an information processing system according to an embodiment of the present disclosure;

FIG. 2 is a block diagram illustrating a configuration of an information processing apparatus according to the embodiment of the present disclosure; and

FIG. 3 is a flowchart illustrating operations of the information processing apparatus according to the embodiment of the present disclosure.

### DETAILED DESCRIPTION

An embodiment of the present disclosure will be described below with reference to the drawings.

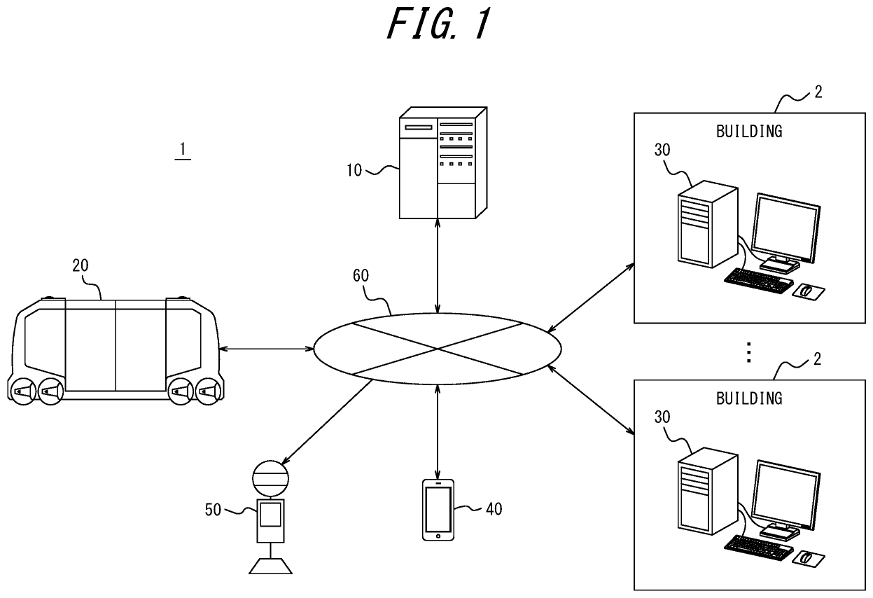

FIG. 1 is a diagram illustrating a configuration of an information processing system 1 according to the embodiment of the present disclosure. The configuration and outline of the information processing system 1 according to the embodiment of the present disclosure will be described with reference to FIG. 1.

The information processing system 1 includes an information processing apparatus 10, a vehicle 20, first terminal apparatuses 30, a second terminal apparatus 40, and a bus stop 50. The information processing apparatus 10, the vehicle 20, the first terminal apparatuses 30, the second terminal apparatus 40, and the bus stop 50 are communicably connected via a network 60. The network 60 may be a network including a mobile communication network, the Internet, or the like.

Although one information processing apparatus 10 is illustrated in FIG. 1, the number of information processing apparatuses 10 may be two or more. Also, although one vehicle 20 is illustrated in FIG. 1, the number of vehicles may be two or more. Also, although a plurality of first terminal apparatuses is illustrated in FIG. 1, the number of first terminal apparatuses 30 may be arbitrary. Also, although one second terminal apparatus 40 is illustrated in FIG. 1, the number of second terminal apparatuses 40 may be two or more. Also, although one bus stop 50 is illustrated in FIG. 1, the number of bus stops 50 be multiple.

The information processing apparatus 10 generates an operation plan for the vehicle 20 that transports employees in a plant.

The information processing apparatus 10 is, for example, a dedicated computer configured to function as a server. The information processing apparatus 10 may be a general purpose personal computer (PC). The information processing apparatus 10 can communicate with the vehicle 20, the first terminal apparatuses 30, the second terminal apparatus 40, and the bus stop 50 via the network 60.

The vehicle 20 is a vehicle that transports plant employees in the plant. The vehicle 20 may be, for example, a on-premises bus that travels around the plant. The vehicle 20 operates according to the operation plan generated by the information processing apparatus 10.

The vehicle 20 is, for example, a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The vehicle 20 may be a manned vehicle or any autonomous vehicle that travels unmanned.

For example, when the vehicle 20 is an autonomous vehicle, the vehicle 20 acquires information on the operation plan from the information processing apparatus 10 and automatically travels in the plant based on the acquired information on the operation plan.

Each first terminal apparatus 30 is a terminal apparatus installed in a building 2 on the plant's premises. The first terminal apparatus 30 manages a work end time for employees working in the building 2. The first terminal apparatus 30 may manage a work end time for the entire building 2, or a work end time for each production line in the building 2. The first terminal apparatus 30 manages the work end time for the building 2 by input operation by a manager.

The first terminal apparatus 30 controls, for example, a display apparatus in the building 2. The display apparatus is an apparatus capable of displaying the work end time. For example, when the work end time is one hour later than a usual work end time, the first terminal apparatus 30 controls the display apparatus to indicate that the work end time is one hour later. By checking the display on the display apparatus, the employees in the building 2 can confirm the work end time of the day.

Each first terminal apparatus 30 can communicate with the information processing apparatus 10 via the network 60. The first terminal apparatuses 30 may each, for example, be a PC, smartphone, or tablet.

FIG. 1 illustrates the first terminal apparatuses 30 installed in buildings 2, but locations where the first terminal apparatuses 30 are installed are not limited to inside the buildings 2. The first terminal apparatuses 30 may be installed at any locations as long as the first terminal apparatuses 30 can each manage the work end time for the building 2. The configuration is not limited to one terminal apparatus 30 managing the work end time for one building 2. One first terminal apparatus 30 may manage work end times for multiple buildings 2.

The second terminal apparatus 40 is a terminal apparatus owned by an employee of the plant. The second terminal apparatus 40 can communicate with the information processing apparatus 10 via the network 60. The second terminal apparatus 40 may, for example, be a smartphone, tablet, or PC.

The bus stop 50 is located along a route of the vehicle 20 in the plant. The bus stop 50 can communicate with the information processing apparatus via the network 60.

The bus stop 50 acquires information on the operation plan from the information processing apparatus 10. The bus stop 50 can display a timetable at the bus stop 50 based on the acquired information on the operation plan.

The information processing apparatus 10 acquires information regarding a work end time for each building 2 or production line on the plant's premises. The information processing apparatus 10 generates an operation plan for the vehicle 20 based on the acquired information regarding the work end time.

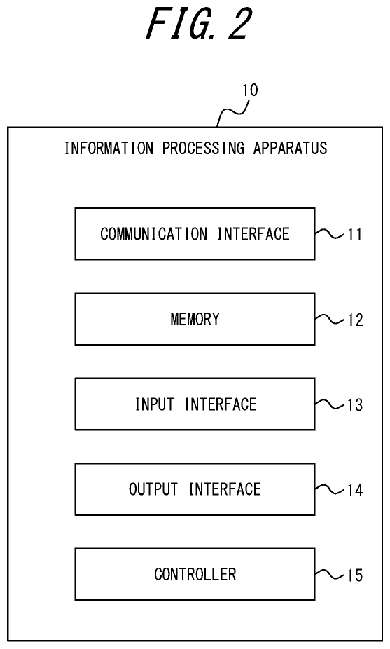

A configuration of the information processing apparatus 10 according to the embodiment of the present disclosure will be described with reference to FIG. 2.

The information processing apparatus 10 includes a communication interface 11, a memory 12, an input interface 13, an output interface 14, and a controller 15.

The communication interface 11 includes a communication module that connects to the network 60. For example, the communication interface 11 may include a communication module corresponding to a local area network (LAN). In an embodiment, the information processing apparatus 10 is connected to the network 60 via the communication interface 11. The communication interface 11 transmits and receives various information via the network 60. The communication interface 11 can communicate with the vehicle 20, first terminal apparatuses 30, second terminal apparatus 40, and bus stop 50 via the network 60.

The memory 12 is, for example, a semiconductor memory, a magnetic memory, an optical memory, or the like, but is not limited to these. The memory 12 may function as, for example, a main memory, an auxiliary memory, or a cache memory. The memory 12 stores any information used for operations of the information processing apparatus 10. For example, the memory 12 may store a system program, an application program, various types of information received by the communication interface 11, and the like. The information stored in the memory 12 may be updated with information received from the network 60 via, for example, the communication interface 11. A portion of the memory 12 may be installed externally to the information processing apparatus 10. In this case, the externally installed portion of the memory 12 may be connected to the information processing apparatus 10 via any appropriate interface.

The input interface 13 includes one or more input interfaces for detecting user input and acquiring input information based on user operation. For example, the input interface 13 includes, but is not limited to, a physical key, a capacitive key, a touch screen integrally provided with a display of the output interface 14, a microphone that accepts audio input, or the like.

The output interface 14 includes one or more output interfaces for outputting information to notify a user. For example, the output interface 14 includes, but is not limited to, a display for outputting information as images, a speaker for outputting information as audio, or the like.

The controller 15 includes at least one processor, at least one dedicated circuit, or a combination thereof. The processor is a general purpose processor, such as a central processing unit (CPU) or a graphics processing unit (GPU), or a dedicated processor specialized for particular processing. The dedicated circuit is, for example, a field-programmable gate array (FPGA) or an application specific integrated circuit (ASIC). The controller 15 executes processes related to operations of the information processing apparatus 10 while controlling components of the information processing apparatus 10.

(Operations of Information Processing System)

Operations of the information processing system 1 illustrated in FIG. 1 will be described with reference to FIGS. 1 and 2.

Upon determining a work end time of the day, a manager of each building 2 inputs information regarding the work end time into the first terminal apparatus 30. The work end time input by the manager may be a work end time for the entire building 2, or a work end time for each production line in the building 2.

When the information regarding the work end time for each building 2 or production line is input, the first terminal apparatus 30 transmits the information regarding the work end time to the information processing apparatus 10.

The communication interface 11 of the information processing apparatus 10 receives the information regarding the work end time transmitted by the first terminal apparatus 30. The controller 15 acquires, via the communication interface 11, the information regarding the work end time transmitted by the first terminal apparatus 30.

Upon acquiring information regarding work end times for all buildings 2 in the plant, the controller 15 generates an operation plan for vehicles 20 based on the acquired information regarding the work end times.

The controller 15 transmits information on the generated operation plan to the vehicles 20 and the bus stop 50 via the communication interface 11.

Upon receiving the information on the operation plan from the information processing apparatus 10, the vehicles 20 travel in the plant based on the received operation plan.

Upon receiving the information on the operation plan from the information processing apparatus 10, the bus stop 50 displays a timetable at the bus stop 50 based on the acquired information on the operation plan.

When an acquired work end time is later than a usual work end time, the controller 15 generates the operation plan for the vehicles 20 so that the number of vehicles 20 to be operated in a time period after the acquired work end time is increased relative to the number of vehicles 20 specified in a usual operation plan.

For example, suppose that the usual work end time is 5:30 p.m. and the acquired work end time is 6:30 p.m. Also assume that around 30 minutes after the work end time is an average time that employees who have finished work arrive at the bus stop 50. In this case, the controller 15 generates the operation plan for the vehicles 20 so that the number of vehicles 20 is increased in a time period around 7:00 p.m., which is 30 minutes after the acquired work end time.

This allows the information processing apparatus 10 to increase the number of vehicles 20 in the time period when the number of employees returning home is high, thus allowing transportation of the employees in the plant with high efficiency.

When a work end time for a particular building 2 is later than a usual work end time, the controller 15 may generate the operation plan for the vehicles 20 so that the number of vehicles 20 to be operated via a bus stop 50 near the building 2 in a time period after the work end time for the building 2 is increased relative to the number of vehicles 20 specified in the usual operation plan.

When a work end time for a particular production line is later than a usual work end time, the controller 15 may generate the operation plan for the vehicles 20 so that the number of vehicles 20 to be operated via a bus stop 50 near a building 2 having the production line in a time period after the work end time for the production line is increased relative to the number of vehicles specified in the usual operation plan.

When the number of vehicles 20 to be operated in the time period after the acquired work end time is increased relative to the number of vehicles 20 specified in the usual operation plan, the controller 15 may determine how much to increase the number of vehicles 20, based on the number of employees in the building 2 or production line whose work end time is later than the usual work end time.

Information on the number of employees in each building 2 and production line may be stored in the memory 12.

When an acquired work end time is later than a usual work end time, the controller 15 generates the operation plan for the vehicles 20 so that the number of vehicles 20 to be operated in a time period after the usual work end time is reduced relative to the number of vehicles 20 specified in the usual operation plan.

For example, assume that the usual work end time is 5:30 p.m., and around 30 minutes after the work end time is an average time that employees who have finished work arrive at the bus stop 50. In this case, since most employees usually arrive at the bus stop 50 around 6:00 p.m., the usual operation plan calls for a higher number of vehicles 20 in a time period around 6:00 p.m.

In this case, when the work end time acquired by the controller 15 is 7:00 p.m., the number of employees arriving at the bus stop 50 around 6:00 p.m. is less than usual. Therefore, the controller 15 generates the operation plan for the vehicles 20 so that the number of vehicles 20 to be operated in the time period around 6:00 p.m. is reduced relative to the number of vehicles 20 specified in the usual operation plan.

This allows the information processing apparatus 10 to reduce the number of vehicles 20 in the time period when the number of employees leaving work is low, thus allowing transportation of employees in the plant with high efficiency.

When the number of vehicles 20 to be operated in the time period after the usual work end time is reduced relative to the number of vehicles 20 specified in the usual operation plan, the controller 15 may generate the operation plan so that a surplus vehicle 20 is used for another application. The controller 15 may, for example, generate the operation plan to use the surplus vehicle 20 for in-house mail.

This allows the information processing apparatus 10 to efficiently use the surplus vehicle 20 for another application.

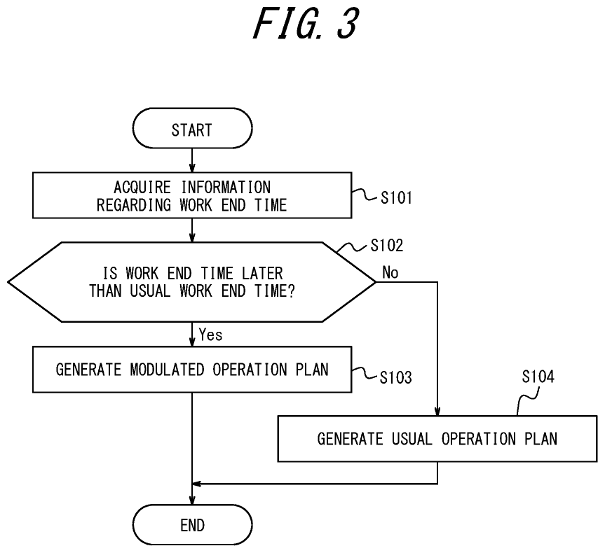

Operations of the information processing apparatus 10 will be described with reference to the flowchart in FIG. 3.

Step S101: The controller 15 of the information processing apparatus acquires information regarding a work end time for each building 2 or production line on the premises of a plant.

Step S102: The controller 15 determines whether the acquired work end time is later than a usual work end time. When the acquired work end time is later than the usual work end time (Yes in step S102), the controller 15 proceeds to step S103. When the acquired work end time is not later than the usual work end time (No in step S102), the controller 15 proceeds to step S104.

Step S103: The controller 15 generates, based on the acquired information regarding the work end time, an operation plan that is modified from a usual operation plan. The controller 15 generates the operation plan for vehicles 20 so that, for example, the number of vehicles 20 to be operated in a time period after the acquired work end time is increased relative to the number of vehicles 20 specified in the usual operation plan.

Step S104: The controller 15 generates the usual operation plan.

(Other Examples for Acquiring Work End Time)

The above embodiment describes a case in which the information processing apparatus 10 acquires information regarding a work end time from the first terminal apparatus 30, but a method for acquiring information regarding a work end time by the information processing apparatus 10 is not limited to this. Other examples for acquiring information regarding a work end time by the information processing apparatus 10 will be described.

A vehicle 20 in operation transmits, to the information processing apparatus 10, information regarding a boarding status of the vehicle 20. The information regarding the boarding status of the vehicle 20 includes information regarding the number of passengers who are on board the vehicle 20.

When an employee who is getting on the vehicle 20 holds a ticket over a reader of the vehicle 20, the vehicle 20 recognizes that the employee holding the ticket has got on the vehicle 20. The ticket may be, for example, an IC card capable of short-range wireless communication with the reader of the vehicle 20. Alternatively, the employee's second terminal apparatus 40 may store information on the ticket and serve as the ticket.

The vehicle 20 grasps the number of employees who have been on board the vehicle 20 by counting the number of tickets read by the reader. Upon grasping the number of passengers, the vehicle 20 transmits, to the information processing apparatus 10, information regarding a boarding status of the vehicle 20.

The vehicle 20 may grasp the number of passengers by another method. For example, the vehicle 20 may estimate the number of passengers by capturing images of the interior of the vehicle 20 by a camera capable of capturing images of the interior of the vehicle 20 and analyzing the captured images.

The communication interface 11 of the information processing apparatus 10 receives the information regarding the boarding status of the vehicle 20 transmitted by the vehicle 20 in operation. The controller 15 acquires, via the communication interface 11, the information regarding the boarding status of the vehicle 20 transmitted by the vehicle 20 in operation.

The controller 15 estimates a work end time based on the information regarding the boarding status of the vehicle 20 acquired from the vehicle 20 in operation, to acquire the work end time.

When the number of passengers in a vehicle 20 that is operated a predetermined time after a usual work end time is less than the number of passengers in usual times, the controller 15 estimates that a work end time of the day is later than the usual work end time.

For example, assume that the usual work end time is 5:30 p.m., and around 30 minutes after the work end time is an average time that employees who have finished work arrive at the bus stop 50. In this case, when the number of passengers who are on board a vehicle 20 operating around 6:00 p.m. is less than the number of passengers in usual times, the controller 15 estimates that the work end time of the day is later than the usual work end time.

(Process when there is Shortage of Vehicles)

When an acquired work end time is later than a usual work end time, the controller 15 generates an operation plan for vehicles 20 so that the number of vehicles 20 to be operated in a time period after the acquired work end time is increased relative to the number of vehicles 20 specified in a usual operation plan.

However, the operation plan with the increased number of vehicles 20 by a desired number cannot be generated owing to a shortage of the number of vehicles 20 to be operable after the acquired work end time. In this case, the controller 15 prioritizes employees who are presumed to use a vehicle 20 and transmits, to second terminal apparatuses 40 of employees with low priority, a message to request the employees with the low priority not to use the vehicle 20.

The controller 15, for example, gives higher priority to employees who use far parking spaces and lower priority to employees who use near parking spaces. The information processing apparatus 10 can thereby allow the employees who travel long distances by the vehicle 20 to board the vehicle 20.

Information on which parking space each employee has parked an own private car may be stored in the memory 12 of the information processing apparatus 10.

The controller 15 may, for example, estimate which employee uses which vehicle 20 based on information on a work end time for a building 2 or production line to which the employee belongs. Alternatively, the controller may, for example, estimate which employee uses which vehicle 20 based on information on a past boarding history of the employee.

Upon prioritizing the employees, the controller 15 transmits, to the second terminal apparatuses 40 of the employees with low priority, the message to request the employees with the low priority not to use the vehicle via the communication interface 11.

As described above, in the information processing apparatus 10 according to the present embodiment, the controller 15 acquires information regarding a work end time for each building 2 or manufacturing line on the premises of a plant, and generates, based on the acquired information regarding the work end time, an operation plan for vehicles 20 that transport employees in the plant. This allows the information processing apparatus 10 to generate the operation plan for the vehicles 20, taking into account of fluctuating work end times, such as the work end time for each building 2 or production line on the premises of the plant. Therefore, according to the information processing apparatus 10 of the present embodiment, the operation plan to transport the employees with high efficiency in the plant can be generated.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

For example, some processing operations performed in the information processing apparatus 10 in the above embodiment may be performed in the vehicle 20, the first terminal apparatus 30, or the second terminal apparatus 40. For example, some processing operations performed in the vehicle 20, the first terminal apparatus 30, or the second terminal apparatus 40 in the above embodiment may be performed in the information processing apparatus 10.

For example, a configuration that causes a general purpose electronic device such as a smartphone, a computer, or the like to function as the information processing apparatus 10 according to the embodiment described above is possible. Specifically, a program in which processes for realizing the functions of the information processing apparatus 10 or the like according to the embodiment are written may be stored in a memory of the electronic device, and the program may be read and executed by a processor of the electronic device. Accordingly, in an embodiment, the present disclosure can also be implemented as a program executable by a processor.

Examples of some embodiments of the present disclosure are described below. However, it should be noted that the embodiments of the present disclosure are not limited to these examples.

[Appendix 1] An information processing apparatus configured to generate an operation plan for a vehicle transporting employees in a plant, the information processing apparatus comprising a controller configured to:
acquire information regarding a work end time for each building or production line on the plant's premises; and
generate the operation plan based on the information regarding the work end time.

[Appendix 2] The information processing apparatus according to appendix 1, wherein the controller is configured to acquire the information regarding the work end time from a terminal apparatus managing the work end time for the building or production line.

[Appendix 3] The information processing apparatus according to appendix 1, wherein the controller is configured to:
acquire, from the vehicle in operation, information regarding a boarding status of the vehicle; and
estimate the work end time based on the information regarding the boarding status, to acquire the information regarding the work end time.

[Appendix 4] The information processing apparatus according to any one of appendices 1 to 3, wherein when the acquired work end time is later than a usual work end time, the controller is configured to generate the operation plan so that a number of vehicles to be operated in a time period after the acquired work end time is increased relative to a number specified in a usual operation plan.

[Appendix 5] The information processing apparatus according to any one of appendices 1 to 4, wherein when the acquired work end time is later than a usual work end time, the controller is configured to generate the operation plan so that a number of vehicles to be operated in a time period after the usual work end time is reduced relative to a number specified in a usual operation plan.

[Appendix 6] The information processing apparatus according to appendix 5, wherein when the number of the vehicles to be operated in the time period after the usual work end time is reduced relative to the number specified in the usual operation plan, the controller is configured to generate the operation plan so that a surplus vehicle is used for another application.

[Appendix 7] The information processing apparatus according to any one of appendices 1 to 6, wherein when there is a shortage of vehicles to be operable after the acquired work end time, the controller is configured to prioritize employees who are presumed to use a vehicle and transmit, to a terminal apparatus of an employee with low priority, a message to request the employee with the low priority not to use the vehicle.

[Appendix 8] A program configured to cause a computer to execute operations, the computer being configured to generate an operation plan for a vehicle transporting employees in a plant, the operations comprising:
acquiring information regarding a work end time for each building or production line on the plant's premises; and
generating the operation plan based on the information regarding the work end time.

[Appendix 9] The program according to appendix 8, wherein the acquiring of the information regarding the work end time includes acquiring the information regarding the work end time from a terminal apparatus managing the work end time for the building or production line.

[Appendix 10] The program according to appendix 8, wherein the acquiring of the information regarding the work end time includes:
acquiring, from the vehicle in operation, information regarding a boarding status of the vehicle; and
estimating the work end time based on the information regarding the boarding status, to acquire the information regarding the work end time.

[Appendix 11] The program according to any one of appendices 8 to 10, wherein when the acquired work end time is later than a usual work end time, the operations further comprise generating the operation plan so that a number of vehicles to be operated in a time period after the acquired work end time is increased relative to a number specified in a usual operation plan.

[Appendix 12] The program according to any one of appendices 8 to 11, wherein when the acquired work end time is later than a usual work end time, the operations further comprise generating the operation plan so that a number of vehicles to be operated in a time period after the usual work end time is reduced relative to a number specified in a usual operation plan.

[Appendix 13] The program according to appendix 12, wherein when the number of vehicles to be operated in the time period after the usual work end time is reduced relative to the number specified in the usual operation plan, the operations further comprise generating the operation plan so that a surplus vehicle is used for another application.

[Appendix 14] The program according to any one of appendices 8 to 13, wherein when there is a shortage of vehicles to be operable after the acquired work end time, the operations further comprise prioritizing employees who are presumed to use a vehicle and transmitting, to a terminal apparatus of an employee with low priority, a message to request the employee with the low priority not to use the vehicle.

[Appendix 15] An information processing method performed by an information processing apparatus configured to generate an operation plan for a vehicle transporting employees in a plant, the information processing method comprising:
acquiring information regarding a work end time for each building or production line on the plant's premises; and
generating the operation plan based on the information regarding the work end time.

[Appendix 16] The information processing method according to appendix 15, wherein the acquiring of the information regarding the work end time includes acquiring the information regarding the work end time from a terminal apparatus managing the work end time for the building or production line.

[Appendix 17] The information processing method according to appendix 15, wherein the acquiring of the information regarding the work end time includes:
acquiring, from the vehicle in operation, information regarding a boarding status of the vehicle; and
estimating the work end time based on the information regarding the boarding status, to acquire the information regarding the work end time.

[Appendix 18] The information processing method according to any one of appendices 15 to 17, further comprising, when the acquired work end time is later than a usual work end time, generating the operation plan so that a number of vehicles to be operated in a time period after the acquired work end time is increased relative to a number specified in a usual operation plan.

[Appendix 19] The information processing method according to any one of appendices 15 to 18, further comprising, when the acquired work end time is later than a usual work end time, generating the operation plan so that a number of vehicles to be operated in a time period after the usual work end time is reduced relative to a number specified in a usual operation plan.

[Appendix 20] The information processing method according to appendix 19, further comprising, when the number of vehicles to be operated in the time period after the usual work end time is reduced relative to the number specified in the usual operation plan, generating the operation plan so that a surplus vehicle is used for another application.

1. An information processing apparatus configured to generate an operation plan for a vehicle transporting employees in a plant, the information processing apparatus comprising a controller configured to:
acquire information regarding a work end time for each building or production line on the plant's premises; and
generate the operation plan based on the information regarding the work end time.

2. The information processing apparatus according to claim 1, wherein the controller is configured to acquire the information regarding the work end time from a terminal apparatus managing the work end time for the building or production line.

3. The information processing apparatus according to claim 1, wherein the controller is configured to:
acquire, from the vehicle in operation, information regarding a boarding status of the vehicle; and
estimate the work end time based on the information regarding the boarding status, to acquire the information regarding the work end time.

4. The information processing apparatus according to claim 1, wherein when the acquired work end time is later than a usual work end time, the controller is configured to generate the operation plan so that a number of vehicles to be operated in a time period after the acquired work end time is increased relative to a number specified in a usual operation plan.

5. The information processing apparatus according to claim 1, wherein when the acquired work end time is later than a usual work end time, the controller is configured to generate the operation plan so that a number of vehicles to be operated in a time period after the usual work end time is reduced relative to a number specified in a usual operation plan.

6. The information processing apparatus according to claim 5, wherein when the number of vehicles to be operated in the time period after the usual work end time is reduced relative to the number specified in the usual operation plan, the controller is configured to generate the operation plan so that a surplus vehicle is used for another application.

7. The information processing apparatus according to claim 1, wherein when there is a shortage of vehicles to be operable after the acquired work end time, the controller is configured to prioritize employees who are presumed to use a vehicle and transmit, to a terminal apparatus of an employee with low priority, a message to request the employee with the low priority not to use the vehicle.

8. A non-transitory computer readable medium storing a program configured to cause a computer to execute operations, the computer being configured to generate an operation plan for a vehicle transporting employees in a plant, the operations comprising:
acquiring information regarding a work end time for each building or production line on the plant's premises; and
generating the operation plan based on the information regarding the work end time.

9. The non-transitory computer readable medium according to claim 8, wherein the acquiring of the information regarding the work end time includes acquiring the information regarding the work end time from a terminal apparatus managing the work end time for the building or production line.

10. The non-transitory computer readable medium according to claim 8, wherein the acquiring of the information regarding the work end time includes:
acquiring, from the vehicle in operation, information regarding a boarding status of the vehicle; and
estimating the work end time based on the information regarding the boarding status, to acquire the information regarding the work end time.

11. The non-transitory computer readable medium according to claim 8, wherein when the acquired work end time is later than a usual work end time, the operations further comprise generating the operation plan so that a number of vehicles to be operated in a time period after the acquired work end time is increased relative to a number specified in a usual operation plan.

12. The non-transitory computer readable medium according to claim 8, wherein when the acquired work end time is later than a usual work end time, the operations further comprise generating the operation plan so that a number of vehicles to be operated in a time period after the usual work end time is reduced relative to a number specified in a usual operation plan.

13. The non-transitory computer readable medium according to claim 12, wherein when the number of vehicles to be operated in the time period after the usual work end time is reduced relative to the number specified in the usual operation plan, the operations further comprise generating the operation plan so that a surplus vehicle is used for another application.

14. The non-transitory computer readable medium according to claim 8, wherein when there is a shortage of vehicles to be operable after the acquired work end time, the operations further comprise prioritizing employees who are presumed to use a vehicle and transmitting, to a terminal apparatus of an employee with low priority, a message to request the employee with the low priority not to use the vehicle.

15. An information processing method performed by an information processing apparatus configured to generate an operation plan for a vehicle transporting employees in a plant, the information processing method comprising:
acquiring information regarding a work end time for each building or production line on the plant's premises; and
generating the operation plan based on the information regarding the work end time.

16. The information processing method according to claim 15, wherein the acquiring of the information regarding the work end time includes acquiring the information regarding the work end time from a terminal apparatus managing the work end time for the building or production line.

17. The information processing method according to claim 15, wherein the acquiring of the information regarding the work end time includes:
acquiring, from the vehicle in operation, information regarding a boarding status of the vehicle; and
estimating the work end time based on the information regarding the boarding status, to acquire the information regarding the work end time.

18. The information processing method according to claim 15, further comprising, when the acquired work end time is later than a usual work end time, generating the operation plan so that a number of vehicles to be operated in a time period after the acquired work end time is increased relative to a number specified in a usual operation plan.

19. The information processing method according to claim 15, further comprising, when the acquired work end time is later than a usual work end time, generating the operation plan so that a number of vehicles to be operated in a time period after the usual work end time is reduced relative to a number specified in a usual operation plan.

20. The information processing method according to claim 19, further comprising, when the number of vehicles to be operated in the time period after the usual work end time is reduced relative to the number specified in the usual operation plan, generating the operation plan so that a surplus vehicle is used for another application.
